(19) United States
(12) Patent Application Publication
(10) Pub. No.: US 2004/0083479 A1
(43) Pub. Date: Apr. 29, 2004

(54) Method for organizing multiple versions of XML for use in a contact center environment

(76) Inventors: Oleg Bondarenko, San Francisco, CA (US); Nikolay Anisimov, Concord, CA (US)

Correspondence Address: CENTRAL COAST PATENT AGENCY, PO BOX 187, AROMAS, CA, 95004, US

(21) Appl. No.: 10/335,637

(22) Filed: Dec. 30, 2002

Related U.S. Application Data
(63) Continuation-in-part of application No. 10/289,581, filed on Nov. 6, 2002.
Application No. 10/289,581 is a continuation-in-part of application No. 10/279,435, filed on Oct. 23, 2002.

(51) Int. Cl. G06F 15/163

(52) U.S. Cl. 719/310

(57) ABSTRACT

An object-oriented business application for controlling event sequences expressed in variant descriptive languages and application specificities has at least one process object defining a specification describing at least one process and at least one process instance materializing as an active process thread upon execution of the at least one process object. The business application activates upon receipt of an event or sequence thereof associated with all or part of the at least one process object whereupon the application triggers execution of the at least one process object thereby activating at least one process instance that controls processing and termination of an interaction sequence including processing post sequence-termination tasks, the application and functions thereof expressed in an abstraction of the variant descriptive languages of the events and sequences thereof.

### CROSS-REFERENCE TO RELATED DOCUMENTS

The present invention is a continuation-in-part (CIP) to copending U.S. patent application Ser. No. 10/289,581, entitled “Method and Apparatus for Providing Real-Time Contact center Reporting Data to Third-Party Applications over a Data Network”, which was filed on Nov. 6, 2002, and which is a CIP to U.S. patent application Ser. No. 10/279,435 entitled “Method and Apparatus for Extending Contact Center Configuration Data for Access by Third-Party Applications over a Data Network”, filed on Oct. 23, 2002, disclosures of which are included in their entirety herein at least by reference.

### FIELD OF THE INVENTION

The present invention is in the field of contact center management, and pertains particularly to methods and apparatus for organizing multiple XML versions used for object and entity description in an interactive multimedia-capable contact center environment.

### BACKGROUND OF THE INVENTION

Modern contact centers are becoming multimedia capable and often service both analog and various forms of digital media interactions. In order to service a large public client base, state-of-art telecommunications equipment, software applications, and various dedicated servers are compiled and integrated with state-of-art software platforms. In addition to managing very high levels of communication events of various media types, internal management duties must be performed within the center itself. Such duties include tracking and managing historical data, client data, product data, service personnel data, and center configuration data. Moreover, many contact center hosts have multiple service sites that are connected through networks both analog and digital.

The inventors know of an object-oriented, contact-center management system that is currently used within some centers. The system provides tools for client/agent interaction management, intelligent routing, historical database reporting, statistics compilation and reporting, communication event load balancing, and configuration management. Parts of the system are distributed, for example, to agent desktop terminals for contact management. Servers are provided to facilitate different media types such as chat, e-mail, and so on. Parts of the system are distributed to telephony switches to provide intelligent routing and client interaction capability both from within the system and in some cases into the event sponsoring networks. The system is automated in many respects and updates to configuration parameters of the system are made periodically to add new equipment, reconfigure agent desktop applications, re-assign personnel to various duties, configure local telephony switches for agent level routing, and other duties.

Due to an extraordinary large number of distributed components and software applications, configuration parameters that must be tracked and managed are quite numerous. The above-described system provides management tools to contact-center administrators for managing and manipulating configuration parameters. For example, a configuration server and configuration manager application is provided and accessible to administrators. The tools use a configuration code library to identify, change and distribute configuration updates throughout the system.

A drawback to this system is that it is mostly internally administered using proprietary code and is platform-dependant. Contact-center administrators access the configuration server through an application program interface from a local area network that is typically Transfer Control Protocol/Internet Protocol (TCP/IP) enabled. A vehicle that is based on extensible markup language (XML) is available and known to the inventor for transmitting contact-center configuration data from one cooperating contact center to another in the case of multi-site centers. The vehicle is limited however, in that manipulation of data cannot be performed on the fly. Therefore, it is not suitable for third-party integration of center configuration data with other third-party management facilities such as customer-relations management (CRM) applications.

The inventors know of a system for transforming and transmitting contact-center configuration and service data from a contact-center environment to one or more platform-disparate third-party applications over a data network. The system is described in the specification listed as a reference in the background section of this specification. The system includes an intermediate service point connected to the network between communicating parties and a set of application program interfaces for transforming and transmitting contact-center data from the center to the intermediate service point. The system also includes a set of application program interfaces for transmitting the contact-center data from the service point to one or more of the third party applications. In practice of the system, Java-based data is sent to the service point from the center and used for instantiating at least one data model, the model described as an XML document, which is rendered accessible in whole or part to a requesting third-party application or applications according to protocol used by the third-party application or applications.

The inventor knows of an enhancement to the system described above. The enhanced system provides contact-center statistical data to a third party application over a data network. Using the architecture described above, a third-party application accesses the intermediate service point and manipulates one or more services hosted within the service point to configure to receive by subscription statistical data about specific contact-center entities described as objects including real time performance statistics of those entities.

There are a variety of known XML-based mechanisms and protocols for enabling relatively platform independent communication and process execution between two or more dedicated parties involved in a contact-center business transaction. However, it should be restated here that a state-of-art contact or contact center (CC), defined in its broadest sense, is a very complex system comprising a variety of telecommunication equipment, computers, and software applications. Such a communication environment may include multimedia communication and interaction processes employing various different types of media, such as email, chat, messenger, instant messenger, voice applications, and intelligent routing routines for telephony applications.

CC applications, in general, can be defined as one or more sets of software components aimed at processing business requests. A typical CC application consists of several logically connected software components distributed over a CC network. Typically, the applications contain some business logic for processing interactions of specific domain types. It is noted herein that each CC software component of an application is developed within its own environment using, mainly, its own tools and languages. For example, an interactive voice response (IVR) application is a type of customer-oriented CC application that is capable of processing inbound telephone interactions with the aid of interactive voice response and includes possible interaction with human operators, usually referred to as agents.

Mark-up languages used to create and deploy a voice application like an IVR application include VoiceXML (VXML) and call-control XML (CCXML). For example, a simple IVR application with limited call control parameters can be expressed in a single XML document that includes VXML (for voice) and CCXML (for call control). However, as contact centers become more complex in terms of functionality it becomes clear that mark-up languages currently in use, such as VXML and CCXML, function at too low a level to provide for smart interaction required with high-level events.

Although the systems described in the cross-reference section provide relative platform independency from the viewpoint of third-party applications dealing with a single host (contact center environment), the host must employ a plurality of application program interfaces (APIs) on both sides of the interface server. Moreover, on the host side of the interface server the communication is entirely proprietary. On the customer side, data models and transformation logic must be included to ensure application specific rendering.

Third-party applications are developed in their own environments and use their own mark-up languages, as are differing components of a complex CC application. For example, a voice application is developed with tools specific to voice application logic creation and manipulation while call-control routines are developed with an entirely different set of tools. These components must be integrated using APIs and must be enabled according to different sets of business rules within the center. When speaking of XML in general, there are essentially two well-known entities involved aside from packaging and delivery mechanisms. These are the XML content and the XML instructions for treating the content.

A CC application that is very complex and provides a large number of modular functions will require a very large array of APIs and separate business rules that treat the separate application domains integrated into the application as a whole. Much programming depth is required to ensure that all of the parts work as a whole from execution to termination of the application and that all of the appropriate business rules and language libraries are successfully applied.

What is clearly needed is a more abstract way of representing and treating various XML-based languages used to implement and manage activities of a contact center. Such a method would enable a contact center to be controlled more by objects and events from a business level view rather than by agents and customers from an event-level view and would also reduce the amount of domain specific business rules required for a typical multi-modal CC application to perform its stated function.

### SUMMARY OF THE INVENTION

In a preferred embodiment of the present invention an object oriented business application for controlling events and sequences the events, the events and sequences expressed in variant descriptive languages and application specificities is provided, comprising at least one process object defining a specification describing at least one process; and at least one process instance materializing as an active process thread upon execution of the at least one process object. The application is characterized in that an event or sequence thereof associated with all or part of the at least one process object triggers execution of the at least one process object activating at least one process instance that controls processing and termination of the event or sequence thereof including processing post termination tasks, the application and functions thereof expressed in an abstraction of the variant descriptive languages and application specificities of the events and sequences thereof.

Also in a preferred embodiment the application controls event sequences occurring in a telephony environment, the event sequences including multimedia interactions. Also in a preferred embodiment the event sequences include party-to-party interactions, party-to-machine interactions, machine-to-machine interactions, and machine-to-party interactions, party defining one of a live agent, a live customer, or a live business partner. In still another embodiment the triggering event is one of an incoming telephone call, an incoming multimedia event, a machine notification, a machine request, or an agent-initiated event. In a further embodiment the event is an incoming telephone call and a processed sequence of events define interaction between a communicating party and an interactive voice response system.

In yet another embodiment of the application the event is an incoming machine request and a processed sequence of events define an automated machine-to-machine request and response sequence. In still another embodiment the events and event sequences are variant from each other in terms of descriptive language and application specificity, the descriptive language variances comprising one or a combination of XML syntax differences, style differences and vocabulary differences. In still another embodiment the abstract descriptive language of the application, process object, and process thread is XML-based and the variances of the different descriptive languages of the events processed or event sequences processed are satisfied during processing by inserting language specific and application specific syntax into variable fields provided within one or more XML-based templates, the syntax available to the application by accessing a language library. In still another embodiment the at least one process instance inserts operation and identification tags during processing XML documents to enable various functions of a contact center platform including communication with other process instances and objects of the process.

In another embodiment of the invention the application further has a plurality of contact-center objects, the objects described in the abstract language of the application, process objects, and process instances, each object corresponding to a counterpart object residing within the contact center platform, the counterpart objects modeled and described at a lower level of abstraction. In some the application functionality is extended to third-party interfaces held externally from the contact center platform enabling platform and application independent processing across multiple domains, and in some cases the interface includes one of an IVR capable telephone switch, a Web server, a LAN server, or a network gateway.

In another aspect of the invention, in a multimedia communications environment, a method for machine processing of multi-modal interaction sequences across multiple application-specific environments according to business application logic is provided, comprising steps of (a) receiving a triggering event at an interfacing node; (b) executing upon trigger a business process object of an object oriented application; (c) spawning at least one process instance for applying the appropriate application business logic to enable the interaction sequence; (d) accessing any related interaction objects of the interaction sequence sequentially according to process instance order; (e) inserting by tagging and executing the order of tasks described by the business application logic during run of the at least one process instance on the accessed objects in sequential order; and (f) terminating the process instance or instances running upon completion of the ordered tasks.

In some preferred embodiments, in step (a), the triggering event is one of an incoming call, an incoming multimedia request, a machine notification, a machine request, or an interaction request initiated by an application or live party. Also in some embodiments, in step (a), the interfacing node is one of a telephony switch, a Web server, or a network gateway. Also in some embodiments, in step (b), the object oriented application uses an abstraction of XML based language at least one level of abstraction above the levels of XML based languages of the application specific domains of the parties of the interaction or event sequences. In still other embodiments, in step (b), the process object provides at least one XML template with variable fields therein for inserting syntax of application specific nature and for inserting tags to enable transient processes executing functional tasks.

In yet other embodiments of the method, in step (c), more than one process instance is spawned in response to a single triggering event. I still other embodiments, in step (d), the process instance works with abstract objects, each abstract object having a counterpart object of a lower abstraction residing within the domain of the host of the communications environment. In still further embodiments, in step (e), the tags are inserted into variable fields of an XML document, the tags themselves containing variables for selection and execution according to prevailing business logic. In still further embodiments, in step (e), the at least one process instance includes logic for completing tasks after an interaction sequence terminates. Finally, in still further embodiments, in step (e), a post interaction task includes one or a combination of revenue reporting, statistical reporting, profile updating, and historical updating according to results of processing.

### BRIEF DESCRIPTION OF THE DRAWINGS FIGURES

FIG. 1 is an architectural overview of an interface sever for bridging third-party applications to contact-center configuration environment according to an embodiment of the present invention.

FIG. 2 is an architectural overview of the configuration service of FIG. 1 and network connection between third-party applications and a contact center configuration management environment.

FIG. 3 is an architectural overview of the internal components of the configuration service of FIG. 1 according to an embodiment of the invention.

FIG. 4 is a data model example of a configurable component according to an embodiment of the invention.

FIG. 5 is a block diagram illustrating a third-party interface server and network connections to contact-center resources and to third party applications according to an embodiment of the present invention.

FIG. 6 is process flow chart illustrating steps for client and server-side interaction according to an embodiment of the invention.

FIG. 7 is a process flow diagram illustrating steps for interacting with the configuration service of the interface server of FIG. 5 according to an embodiment of the invention.

FIG. 8 is a process flow diagram illustrating steps for third-party access to statistical information according to an embodiment of the invention.

FIG. 9 is a process flow diagram illustrating steps for client authentication according to an embodiment of the invention.

FIG. 10 is a basic architectural overview of a contact center running an IVR voice application.

FIG. 11 is an architectural overview of the contact center of FIG. 10 enhanced with a system for providing XML object and event description at a higher level of abstraction than application-specific XML implementations.

FIG. 12 is a block diagram illustrating hierarchy of abstract XML description and elements it controls.

FIG. 13 is an architectural diagram illustrating application deployment logistics of the present invention in a third-party scenario.

### DESCRIPTION OF THE PREFERRED EMBODIMENTS

According to a preferred embodiment of the present invention, the inventor provides a method and apparatus for enabling platform-independent data access to contact center configuration data for use by third-party applications. The methods and apparatus of the invention are described in detail below.

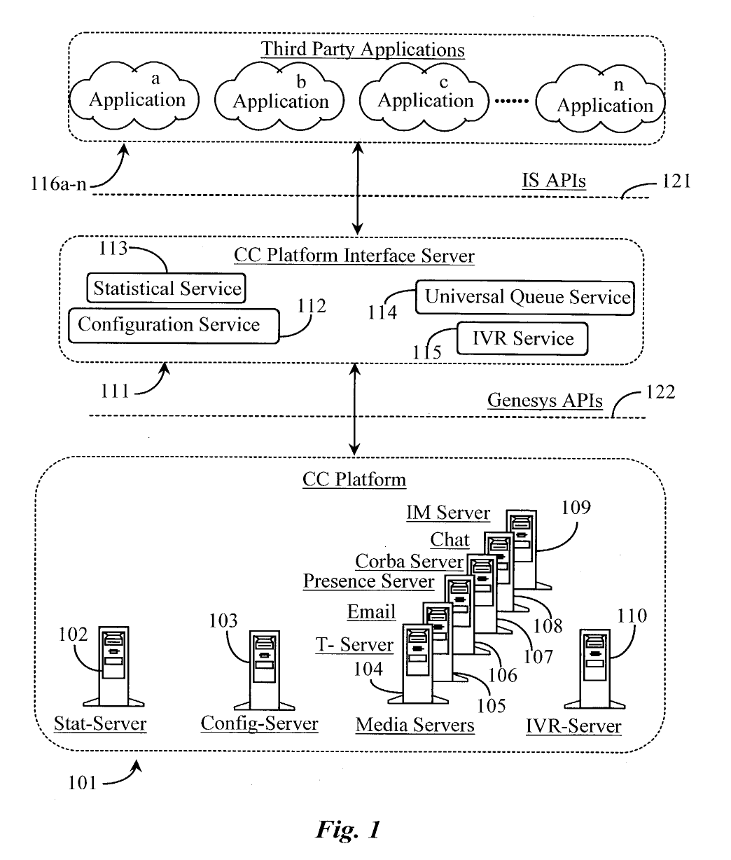

FIG. 1 is an architectural overview of an interface sever 111 for bridging third-party applications 116a-n to contact-center configuration environment 101 according to an embodiment of the present invention. Contacts-center platform 101 is a state-of-art object-oriented platform that is enabled by a rather complex data-model that can change dynamically in terms of attributes of the model. Platform capabilities equate, essentially to available services made possible through provision of equipment and software that enable a state-of-art contact-center environment.

Platform 101 includes a plurality of media-based interaction services illustrated as a plurality of media servers. For example, a transaction server T-Server 104 serves intelligent routing routines including queuing protocols and the like. T-server 104 operates according to contact center rules and may initiate routing routines based on a wide variety of conditions and available data. For example, agent-level routing may be performed based on agent availability, agent skill level, statistical conditions, call load conditions, and combinations thereof. T-server 104 forms the heart of center service in terms of efficient routing of all media type interactions. Although not illustrated in this embodiment, T-server 104 also handles all connection-oriented switched network (COST) interaction routing.

An e-mail server 105 is illustrated in this example and provides a central routing point for all incoming and outgoing e-mails, and video mails. A presence server 106 is illustrated in this example and is adapted to report presence information on all agent or system destinations that may be involved in interaction events. A chat server 108 is illustrated in this example and is adapted as a central server for hosting scheduled and impromptu chat sessions party to clients and typically hosted by one or more dedicated service agents. An instant message (IM) server 109 is illustrated in this example and is adapted for brokering instant messages between agents in the center and in some cases, between agents and connected clients. A Corba server 107 provides the middleware components required to translate relational data to object-oriented entities and reverse order in an object-oriented telecommunications system environment.

The media server types illustrated in this embodiment should not be collectively quantified as a limitation of services available from within platform 101 as there may be additional services provided without departing from the spirit and scope of the invention. The inventor intends to demonstrate only an exemplary list of the types of services available in a state-of-art contact center environment.

A statistics server (Stat-Server) 102 is illustrated within platform 101 and is adapted to server various and sundry statistical information for aid in better routing and CC performance evaluation. An interactive-voice-response server (IVR-Server) 110 is illustrated in this example and provides control for point-to-point automated interaction with clients both in a computer-telephony-integrated (CTI) COST sense and in an Internet-protocol-network-telephony (IPNT) sense provided that platform 101 is a dual-capable platform (handles COST and DNT interaction). A configuration server 103 is illustrated in this example and is adapted to store and provide configuration data for all systems and entities including software that are utilized within the domain of platform 101.

It is assumed in this example, that all servers represented within the domain of platform 101 are interconnected for communication and data access by at least an internal local-area-network (LAN) that also connects agents and administrators for communication and data access. It is also assumed that the domain of platform 101 is not strictly limited in a physical sense as some servers described above may be distributed singularly or in plural to network-level points outside of a contact center.

As was described with reference to the background section, there are a relative large number of configuration parameters relating to equipment, software and services of platform 101 that must be managed and updated to provide continual and optimal function of the center as a whole. As center capabilities and services are upgraded and, perhaps added to the system, configuration parameters related to those changes must be saved and stored for later access. If a center-host has multiple center locations, then the configuration data for center equipment and services must be duplicated in part or in whole and distributed to sister sites for implementation. In current art, this assumes that same equipment types, connection types, and software are used at all of the cooperating sites. Furthermore, in the time that it takes to configure multiple sites for active service, original configuration data elements may have been modified, upgraded, replaced with other configuration data and so on. Because current data synchronization implements are proprietary and are built around a common platform, third-party applications and systems that operate according to variant platforms are excluded from participation.

In order to solve the described limitations of same-platform, proprietary data synchronization vehicles, the inventors provide a unique contact-center platform-interface server 111. Server 111 uses a variety of accepted and standard descriptive languages to promote data access and synchronization capabilities to third-party applications 116a-n that may not be based on the same platform or even use the same system components or software. Platform interface server 111 makes current configuration data and center related data available on request or, in some embodiments, following a data push model.

Platform interface server 111 communicates with the contact center platform through one or more application program interfaces (APIs) 122. Server 111, in a preferred embodiment is hosted on the Internet network in the form of a universal Web-service accessible to all authorized parties. In another embodiment, server 111 may be held internal to platform 101 and accessible through a private network. In still another embodiment, server 111, or a version thereof, may be provided as a CTI-service control point (SCP) in a COST network such as the public-switched-telephony-network.

The main responsibility of interface server 111 is to take in all applicable data from the contact center environment and transform the data into standard descriptive language that can be understood and utilized by a variety of third party systems and applications.

Server 111 contains a configuration service 112 for relaying critical configuration data for the purpose of enabling third-party applications 116a-n to configure their sites and systems for interaction with the contact center platform and to operate in a whole or limited fashion as the original contact center would. Server 111 also provides a statistics service 113 that renders current statistics related to performance, load balancing, and other types of functions generic to the host platform available to third-party applications 116. Server 111 offers a universal queue service 114 adapted to provide optimum queuing services and configuration to applications 116a-n. Server 111 also provides an IVR service that can be used by applications 116a-n to interact with their clients.

Applications 116a-n comprise exemplary third-party telecommunications applications. Applications may consist of DNT telephony applications, CTI applications, CRM applications, and so on. It is assumed in this example, that applications 116a-n are known to the inventor and that application program interfaces have been developed that enable them to use the present invention successfully. Third-party applications communicate with interface server 111 using APIs such as Interface Server (IS) APIs 121.

In one embodiment of the present invention, APIs 121 are actually hosted within platform interface server 111. In this case, a particular third-party application 116a, for example, can select the appropriate interface from a menu provided by server 111. In another embodiment, IS APIs 121 are plug-in client modules that can be distributed to third parties or downloaded from the site by third parties. Third-party applications 116a-n may utilize any required portion of available configuration data and services offered through server 111. For example, a COST only contact center running a variant platform may only require queuing services. In that case, only queuing service data is provided to that particular application.

Server 111 transforms the data itself from contact center platform code to one of a variety of universal and standard descriptive languages. Through API 121, or within server 111 itself, the universal language is then transformed into code applicable to the requesting platform for implementation according to its existing data model. In this way, a third party can implement queue services, for example, that are operated and function according to the common parameters or attributes of both platforms. A requesting platform may not utilize all of the capabilities of service 114 or any other offered service for that matter if the constraints of the equipment supported by the platform are limited. However, the service can be acquired and installed relative to all of the functions that are feasible.

After a third-party application is configured and is using one or more service offered through server 111, then configuration updates can be pushed to the third party as they become existent. Likewise, a third party application can be notified of existing updates and then connect to server 111 for automated synchronization wherein the updates are downloaded and automatically installed. Relatively complex data models, one belonging to the host contact center platform and one belonging to the requesting third party application can be rendered in the same universal descriptive language wherein the likenesses of the models and the differences of the models can be isolated to determine what if any available services can be effectively provided to and configured to the requesting application. There are many possibilities.

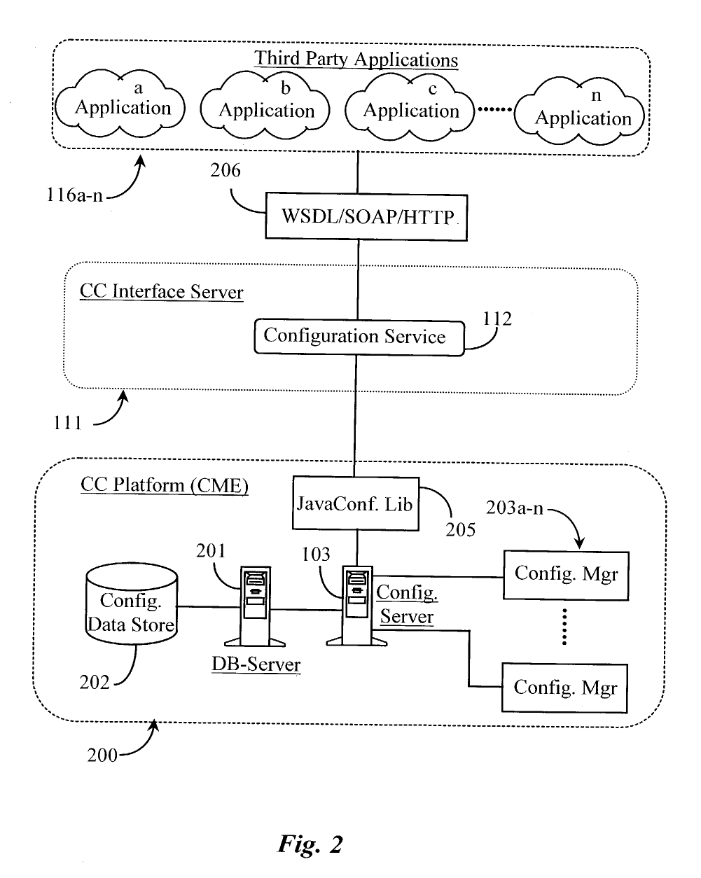

FIG. 2 is an architectural overview of the configuration server 111 of FIG. 1 and network connection between third-party applications 116 and a contact center platform configuration management environment (CME) 200. CME 200 is part of the contact centercontact center platform 101 described with reference to FIG. 1. It is the part that enables configuration management of all servers, processors, software, switches, interfaces, and other like components that make up a telephony contact centercontact center system.

CME 200 comprises configuration server 103 described previously with regard to the example of FIG. 1 and supporting components including configuration manager applications 203a-n, a configuration database repository 202, a database server 201, and a Java configuration library 205.

An instance of configuration manager 203a-n exists for each contact center entity that requires configuration and configuration management services. Instances 203a-n are part of a same extendable program wherein new configuration manager instances can be spawned as required. Configuration manager is installed and executable within server 103 is a preferred embodiment. Server 103 is supported by a repository 202 that contains all of the most current configuration data values for all configurable entities within the CC platform. Database server 201, running database software (not shown) communicates with server 103 to provide data access and update capability of repository 202, such activity performed by server 103.

Server 103 also has access to a Java Configuration Library (JavaConf. Lib.) 205, for the purpose of translating configuration data into Java-based messaging including self executables (beans). Server 111 requests information pertaining to configuration data from server 103 as a result of a request from one of applications 116a-n. Server 111 is an intermediate server that links third-party applications 116a-n to configuration server 103. As previously described, server 111 is in a preferred embodiment, a Web server that may be accessed by third-party applications 116a-n.

Server 111 uses a communication protocol stack 206 that enables Web-Service Description-Language (WSDL), Simple-Object-Access-Protocol (SOAP) messaging, Hyper-Text-Transfer-Protocol (HTTP), and Universal Description, Discovery and Integration UDDI, which are all standard and accepted Web-based protocols. In particular application, contact center configuration data transferred to server 111 from server 103 is presented, in a preferred embodiment as a Web service or as a set of Web services (configuration service 112). Server 111 may use a proprietary data interface to communicate with server 103 while applications 116a-n communicate with server 111 via a secure socket layer (SSL) connection over the Internet for example.

From the point of view of applications 116a-n, the entire configuration of the host contact center platform is presented as an XML document transported using SOAP and HTTP. In a preferred embodiment, the XML-based protocol facilitates reading, updating, and monitoring changes in the XML (configuration) document, for example, values of configuration elements and attributes. The protocol enables manipulation of different elements without changing the whole document (configuration) and also notifying any client application 116a-n about current changes in the XML configuration document, hence changes in configuration data. It is important to note herein that the scope of access to an entire configuration document depends on the nature and scope of the requesting application. In many cases only specific parts of the entire configuration document apply. WDSL and UDDI are languages defining the service structure and enabling identification of service parts or sub-services.

Platform 200 is illustrated in this example as the compilation of components that are relative to configuration service 112. For example, configuration server 103 has instances 209a-n of configuration manager modules. It is assumed in the example that there is a configuration manager for each configurable components of the CC environment. In practice, configuration service 112 facilitates manipulation of configuration manager instances 209a-n utilizing a Java configuration library (JavaConf. Lib) 205. Library 205 contains all of the required Java code to facilitate transport of any configuration data results accessed through configuration service 112.

A configuration database repository 202 is provided to store all of the current configuration elements of the entire contact center platform. A database server 201 is provided having access to repository 202 for serving any requested configuration data, and for storing new configuration data into repository 202 if authorized. In practice of the invention, one or more of applications gain access using Internet protocol (typically request response) to interface sever 111 and configuration service 112, which may include sub-services. Access is controlled through in terms of security through SSL or other applicable regimens. Interface server 111, as a proxy, accesses configuration server 103 through a proprietary interface using Java transport mechanisms and protocols. Result data is transformed from Java to an appropriate protocol for ready implementation at a requesting application site.

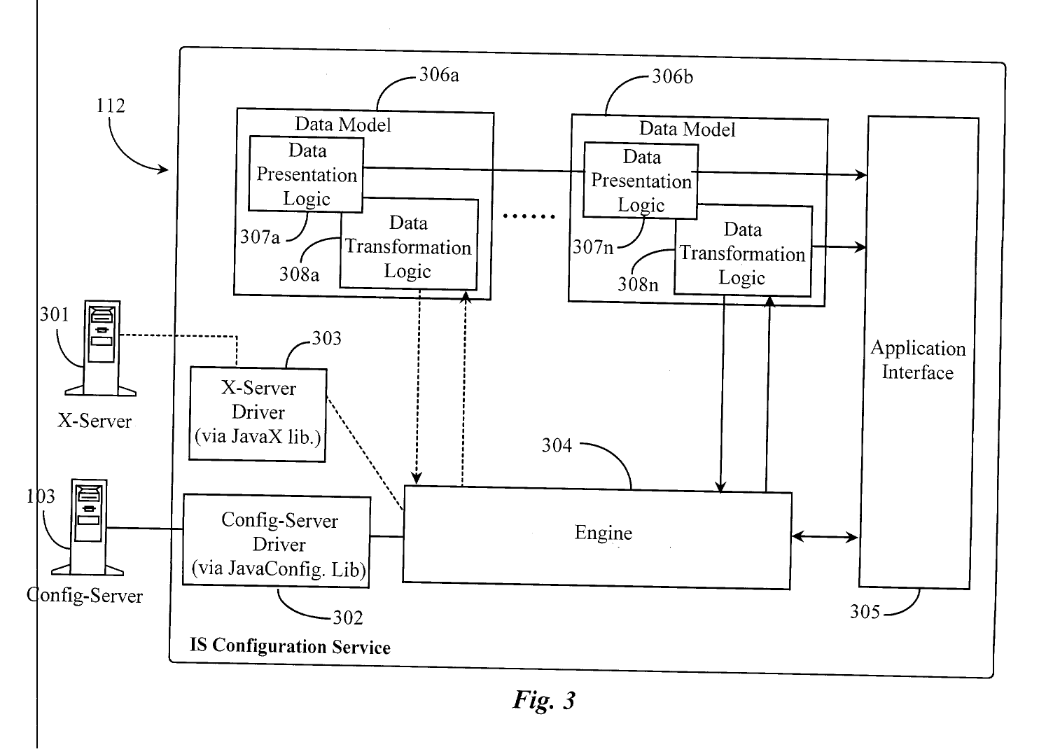

FIG. 3 is an architectural overview of the internal components of the configuration service 112 of FIG. 1 according to an embodiment of the invention. Service 112 presents options to requesting users through an application interface 305. Application interface 305 includes protocol stack 206 described with reference to FIG. 2. Interface 305 functions as an interface for a configuration “wizard” in a preferred embodiment. That is to say the requesting clients operating, for example, through a Web server are presented with a configuration wizard, which would be analogous to configuration service 112 as a whole. Interface 305 is responsible for interface with third party applications 116a-n described with reference to FIG. 2. More particularly, engine 305 parses and generates XML messages and facilitates their transmission via SOAP/HTTP protocol stack 206.

Engine 304 has direct access to configuration server 103 and related components described with reference to FIG. 2 using a configuration server driver 303 that communicates with server 103 through Java library 205 described with reference to FIG. 2. An X-server 301 is illustrated in this example and is adapted to serve pre-selected services such as IVR, queue and statistical services described with reference to FIG. 1 above. X-server 301 is a logical implementation of all of the media servers described with reference to FIG. 1 and communicates with engine 304 using one or more X-server drivers 303 that utilize a JavaX library for code.

Engine 304 is responsible for generation of accurate and up-to-date data models illustrated herein as models 306a and 306n for presenting model-dependant data. Data models 306a through n are exemplary of portions of or entire configuration data models that may be required to full fill third-party requests.

Within each data model 306a-n there are data presentation logic modules 307a-n adapted to present object representative data to third-party applications. Each data model 306a-n also has data transformation modules 308a-n adapted to provide the required transformations into descriptive languages used by third-party applications.

All data model dependant processing as well as all data independent model processing occurs within engine 304. The external representations of data models 306a-n and accompanying modules for presentation and transformation are logically illustrated in this example for explanative purpose only. In practice, it is possible that a configuration data model will contain many object that represent actual contact center entities. Because objects have elements and attributes, a complex network structure emerges wherein several data models share configurable elements and attributes.

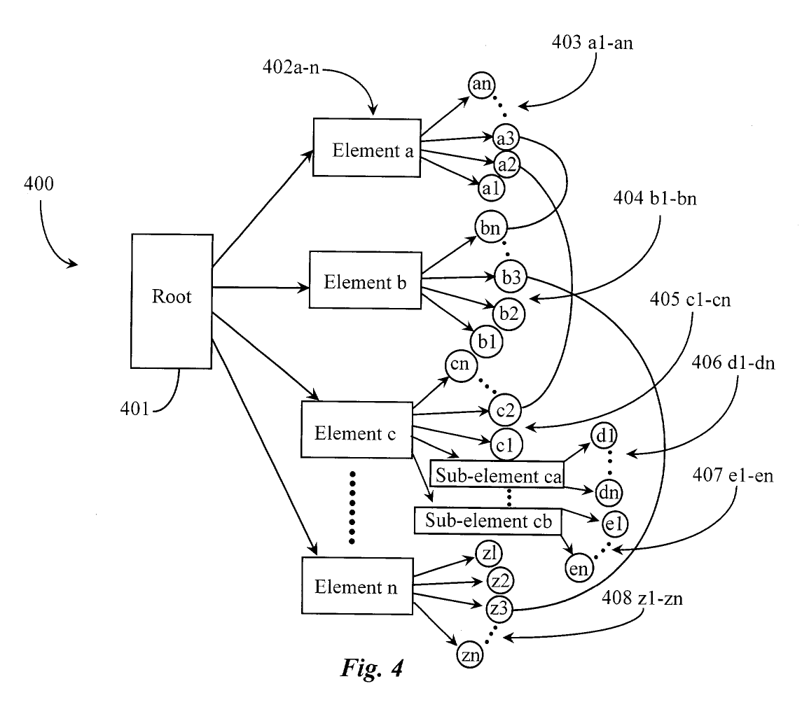

FIG. 4 is a block diagram illustrating an exemplary data model 400 of configurable communication-center elements according to an embodiment of the present invention. Data model 400 is analogous to data models 306a-n described with reference to FIG. 3 above. Model 400 has a root element 401, which is the abstract root of the model. Root 401 may be the entire contact center itself or it may be a portion of the center in a case where only a portion of a data model is required by a third party. Therefore, the term root as applied in this specification implies the main element of the portion of data model presented to a third party.

Root 401 has a plurality of configurable elements 402a-n. Elements 402a-n may represent a wide variety of communication-center objects. Elements 402a-n have attributes. For example, element 402a has attributes 403a1-an. Element 402b has attributes 404b1-bn. Element 402c has attributes 405c1-cn as well as configurable sub-elements, sub-element ca and sub-element cb. Element 402n has attributes 408z1-zn. Sub-element ca has attributes 406d1-dn, and sub-element cb has attributes 407e1-en.

It will be appreciated by one with skill in the art of object modeling that there may, in practice, be many more configurable elements, sub-elements and attributes present and represented in an exemplary model than are illustrated in this example without departing from the spirit and scope of the present invention. The inventor shows modest numbers of elements, sub-elements and attributes for the purpose of simplicity in explanation only.

In object modeling it is known and accepted that there may be more than one sub-element and attribute that occurs in model instantiation wherein the sub-elements and/or attributes are common to more than one configurable element. For example, if root 401 is an agent group and elements 402a-n are current agents logged into the agent group, then attributes of the agents may represent individual agent skills. In this case agent 402a has a skill attribute 403a3 that is identical to an attribute of agent 402b , namely attribute 404bn. Following this logic, agent 402a also has an attribute in common with agent 402c (a2, c2). Likewise, agent 402b has an attribute in common with agent 402n (b3, z3). Therefore, a query using W3C accepted Xpath mechanism may be initiated to find the element b having an attribute equal to, for example, attribute z3 of element n. Then the expression would be /B[@b3=/N[@z3]].

In another example, a third-party may want to read configuration data relevant to one of configurable elements 402a-n, which are in this case agents. If the agent has a name John Smith, then an expression using Xpath would read/person[@LastName=“Smith” and @FirstName=“John” and @is Agent=“1”].

Third-party applications can access contact center configuration data related to a whole of or a portion of a contact center data model. Since a contact center data model has attributes that evolve and change periodically, a third-party application may pre-set to be notified of any specific changes in specific portions of the model that are relevant to the application. For example, if a third-party application wishes to be notified the next time that an outbound call campaign is initiated within the center then it can preset to receive configuration data relative to the campaign including participating agents, switches, servers, and agent attributes including call lists, called numbers, and client identifications. In this case, the third-party application could be a CRM application designed for after care of the target clients solicited by the specific agents involved in the campaign. The desired attributes required by the third party may be the agent call lists, statistics data for each agent hit ratio, percentage of sales per list, and so on. There are many possibilities.

The methods and apparatus of the present invention can be used in a variety of communication-center environments including CTI-COST centers and DNT-capable centers. The present invention can be practiced over a variety of data networks including the Internet network wherein access to configuration data is presented in the form of a Web service or service-set. Other methods for presentation of data to third-party interfaces are also possible. For example, IVR rendition may be used over a COST connection. Wireless Markup Language can be used with a digital cellular telephone or other wireless network device. Third-party thin-client applications and robust third-party mainframe systems alike can benefit from the methods and apparatus of the present invention.

### Transferring Real-Time Object and Performance Data

In one aspect of the present invention, the system described in FIGS. 1-4 is used to provide object status and performance data in real-time to requesting third-party applications.

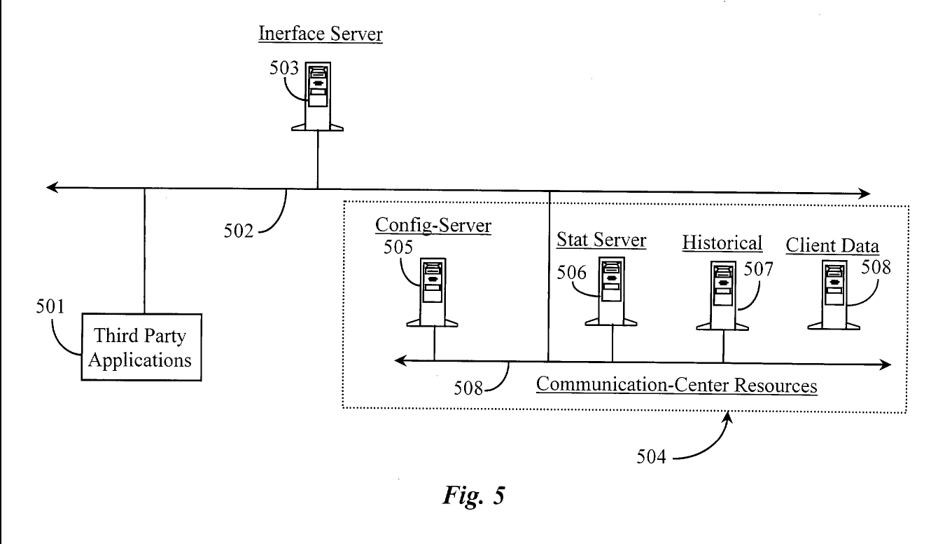

FIG. 5 is a block diagram illustrating a third-party interface server 503 and network connections to communication-center resources 504 and to third party applications 501 according to an embodiment of the present invention. Interface server 503 is analogous to interface server 111 of FIG. 1 above. All of the services 112-115 described with reference to FIG. 1 may be assumed to be present in server 503. Server 503 is, in a preferred embodiment, is hosted on the well-known Internet network. However, this should not be construed as a limitation to the practice of the present invention, as other DPNs can be used to host server 503. Server 503 is illustrated as connected to an Internet backbone 502. Backbone 502 represents all of the lines, equipment and connection points that make up the Internet network as a whole. Therefore, there are no geographic limitations to the practice of the invention.

Interface server 503 presents a set of interactive Web services that are accessible through Internet connection and navigation to server 503. Third-party applications 501 have access to services presented within server 503 through Internet connection. Interface server 503 has application program interfaces installed therein analogous to IS APIs 121 of FIG. 1. The APIs enable various third-party applications 501, which may include CRM systems, thin client applications, etc. to have access to Web services of 503 in a secure manner over Internet backbone 502.

Communication-center resources 504 include, but are not limited to a configuration server 505 adapted to serve configuration data, a historical database server 507 adapted to serve history-based data, a statistics server 506 adapted to serve performance-related data, and a client database server 508 adapted to serve client-related data. Interface server 503 has a set of application interfaces analogous to APIs 122 of FIG. 1. APIs 122 are proprietary in nature, are Java-based in a preferred embodiment, and are adapted to transform contact center data into XML-based description used to render models reflecting the communication-center environment. This is accomplished using the previously described processing engine 304.

It is noted herein that communication-center resources may be provided through legacy services using one or more than one legacy system adapted to use a variety of servers and interfaces that may be designed for certain data-types. The inventor illustrates separate machine icons as servers for explanative reason only. The described servers may, in one embodiment, all be hosted on a single machine. As a Web-service host, server 503 in a preferred embodiment is a secure server with identification, authentication and other secure protocols in place. SSL and other standard Web security regimens can be used in combination to provide various levels of security for accessing server 503 from remote third-party applications 501.

An important goal of the present invention is to provide access to CC reporting data. Such access in this example may be a Web service for providing reporting information that would use proven Internet standards such as SOAP, WSDL, UDDI, and HTTP. Server 503 accesses at least configuration server 505 for configuration data and stat server 506 for reportable communication-center data. Third-party applications communicate with server 503 according to a specially designed XML-based protocol. Client/server interaction according to XML-based protocol is described further below.

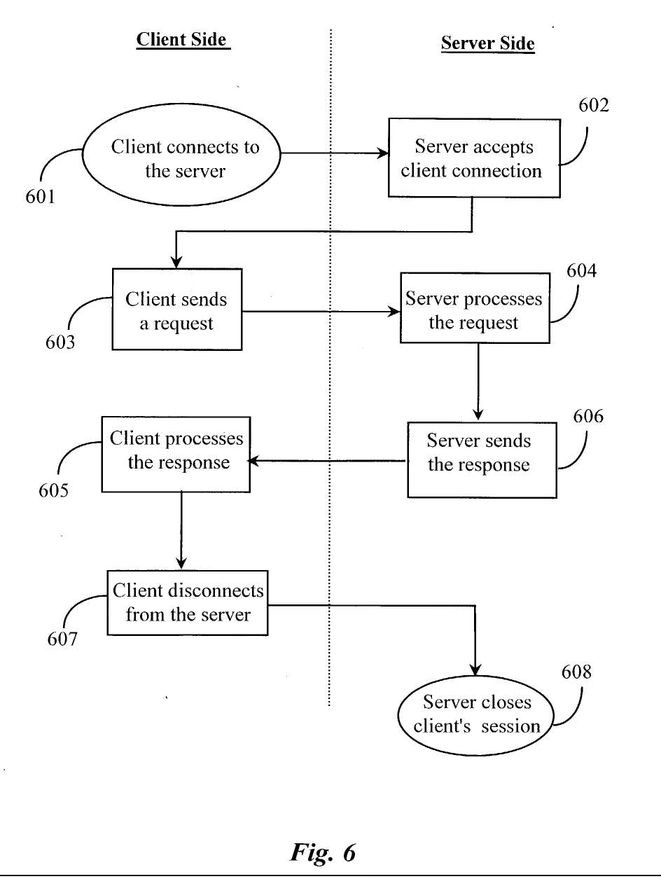

FIG. 6 is a process flow chart illustrating steps for client and server-side interaction according to an embodiment of the invention. In a preferred application of Web-service access as described above, a client first connects to server (503) in step 601. Access may be initiated from any remote Internet-capable device.

Access involves an XML-based protocol for requesting and retrieving CC real-time statistical information, for example. The protocol enables specification of the type of CC statistical information requested by use of predefined metrics and customized metrics. It also enables specification of scheduled information retrieval. Using the XML-based protocol the system enables delivery of statistics data about CC objects, their status, and performance data. Additionally, the system could notify third-party applications (501) about most-recent changes of the CC objects and their status.

At step 602 the server accepts the connection initiated by a client in step 601. Acceptance may, in preferred embodiments, include client-identification and authentication services. SSL transport or other security protocol may also be used for secure connection. At step 603 the client, after being cleared to use services hosted by the server, sends a request to the server. The request is sent as a result of interaction with one of the Web-services hosted in the server. At step 604 the interface server processes the client request. In step 604 the interface server taps the appropriate communication-center resources analogous to resources 504 of FIG. 5. More particularly, the server connects to a configuration server to access configuration data, or to a statistics server to capture most recent statistical data such as object performance data including most recent status.

At step 605 the interface server delivers a response to the requesting client. The response is in the form of a (data) language understood at the client. For example, Java-based data is retrieved from communication-center resources. That data is rendered as a data model described in XML. The API between the client and the interface server handles transfer of the XML data as XML data or in any other markup language that may be required at the client end.

At step 606 the client receives and processes the response from the interface server sent in step 605. Processing the response includes display and any calculation that may be designed at the client end. At step 607 the client disconnects from the interface server. Disconnect involves a client logout action. At step 608 the interface server receives the logout request from the client and closes the active session.

A client request has a reference element that is returned with the response. The reference element uniquely identifies each request and associates appropriate responses. If there is more than one request in a session for example, each request is uniquely identified. There are many ways to accomplish this task. One such method is random serial identification, which would occur each time a request is received. In one embodiment a request may be cancelled en-route. This embodiment assumes that an acknowledgement of the received request is immediately returned to the client with the reference element. In a cancel action, the client would specify the reference element along with the cancellation request thereby identifying which active request will be cancelled. Requests must be cancelled one at a time using the unique reference elements with each cancellation request. One reference element cannot be used to cancel more than one active request in an active session.

In a preferred embodiment, request processing is possible only after the particular request has been successfully authorized according to enterprise rules. For example, the interface server must first confirm that the request from the user is answerable according to the request parameters. In this way a general request such as retrieve “current status” will cause the statistics server, for example, to deny the request because there are no specific parameters. This provides a flexible way to control available functionality for any particular client.

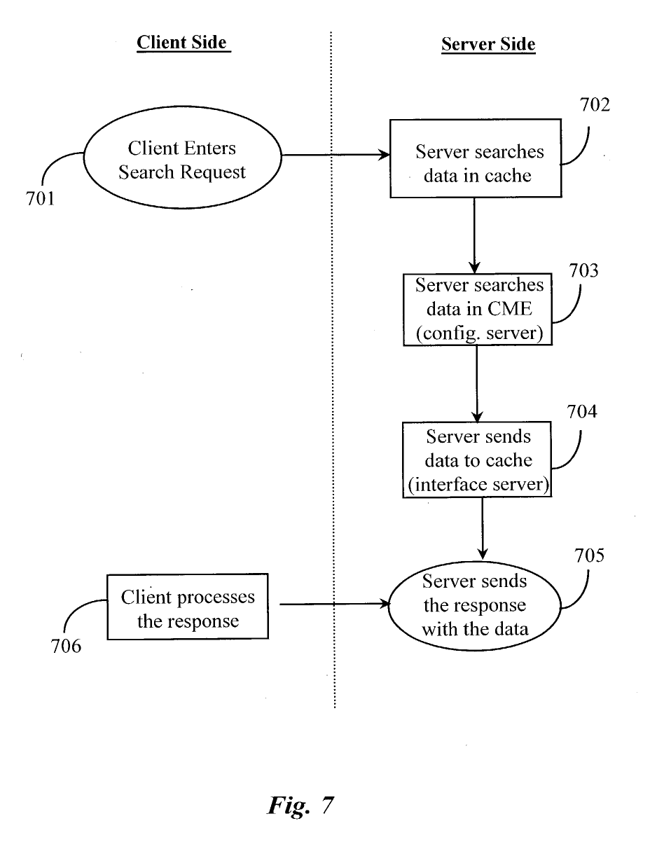

FIG. 7 is a process flow diagram illustrating steps for interacting with the configuration service of server 503 of FIG. 5 according to an embodiment of the invention. To access the configuration service of server 503 a client connects to the interface server as described above with reference to FIG. 6. The client then enters a search request at step 701. It is assumed that the client, in this case, has been authenticated at the server and cleared to use the configuration service. The configuration service is analogous to service 112 of FIG. 1 above.

The configuration service taps into communication-center CME (introduced further above) as a resource for configuration data. A configuration server analogous to server 505 of FIG. 5 serves the data. The configuration service has only one pre-set request (RetrieveConfiguration). At step 701 then, a RetrieveConfiguration request includes search parameters equating to configuration criterion.

At step 702 the interface server first searches its data cache according to the criterion sent in the request of step 701. If the most recent data requested is already in cache then it is sent along with a response. However, this example assumes that the required data is not available in local cache. At step 703 the interface server searches for the data in CME, which is part of the configuration server (505) described with reference to FIG. 5. Data found in the CME is returned to the interface server in step 704 in Directory-Services-Markup-Language (DSML) format. DSML is an XML application that provides a method for expressing directory queries, updates, and the results of these operations. The result is a naming and directory service (NDS) described in XML. The configuration service provides mapping of CME to a hierarchical structure in terms of NDS.

At step 705 the interface server sends the final response along with the configuration data to the client over a secure Web connection. At step 706 the client processes the response. An example of a simple configuration request would be to retrieve the specific configuration of a type of telephony switch. The search parameters would be the criterion surrounding the switch such as type, model, number of ports, and so on. It is important to note herein that a configuration data model for the entire communication-center environment is achievable with a single request however, in typical application only required portions of the data model or perhaps updates would be generated within interface server 505 according to the specific needs of the specific third-party application.

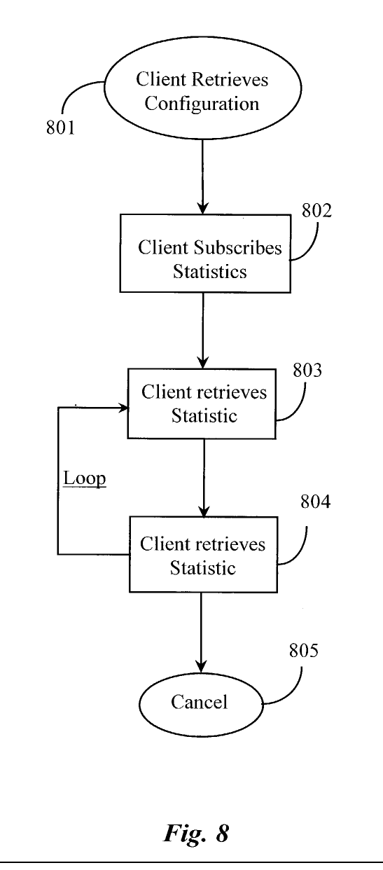

FIG. 8 is a process flow diagram illustrating steps for third-party access to statistical information according to an embodiment of the invention. A statistical service is also provided within interface server 503 of FIG. 5 and is described also with reference to service 113 of FIG. 1. The statistical service taps, as a resource, a statistics server analogous to server 506 described with reference to FIG. 5 above. Available options include being able to subscribe to receive statistics; being able to retrieve statistics on demand; and being able to retrieve statistical profiles such as time-line profiles and so on. The actual requests read SubscribeStatistics, RetrieveStatistics, and RetrieveProfile.

To retrieve one or more statistics on a subscription basis a client first retrieves a basic configuration in step 801. The configuration of step 801 determines how statistics will be delivered according to request criterion. In step 802 the client subscribes to receive statistics according to the current established configuration parameters. At step 803 the client receives a statistic. At step 804 the client receives a next statistic, which may be an update or a change in the previously received statistic. Steps 803 and 804 are continuously repeated during a session until in step 805 the client logs off or cancels the next statistic transaction.

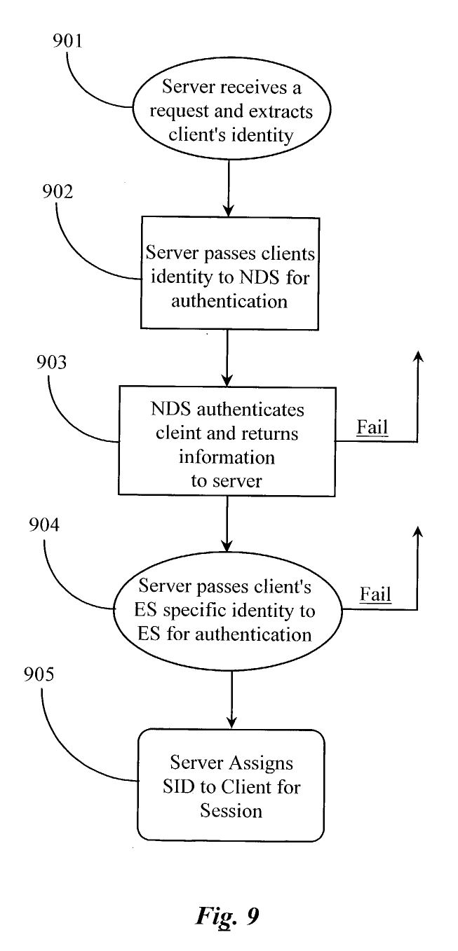

FIG. 9 is a process flow diagram illustrating steps for client authentication according to an embodiment of the invention. In a preferred embodiment, all clients are authorized and cleared to use the services provided by interface server 503 of FIG. 5. As previously described, clients gain access to server 503 over a secure public Web connection while resources are accessed by server 503 over a proprietary data link.

The interface server performs client-request authentication services using the identity parameter referred to above as a reference element that is mandatory for and uniquely identifies any request. The inventor terms this authentication process “Server Authentication”. Sever authentication provides login services and permission to submit requests for services. The interface server, in preferred application, also authenticates a client in terms of an enterprise system (ES) authentication that authorizes the client to use ES features such as the particular services. The two authentication procedures are, in a preferred embodiment, distinguished from one another. However, separating the authentication procedures as described should not be construed as a limitation as they can, in some embodiments, be combined as a single procedure.

In step 901 an interfacing server analogous to server 503 of FIG. 5 receives a request for services and extracts the client identity from the request. If the client requires authentication (optional) then the interface server initiates an authentication procedure. In step 902 the interface server passes the client identity to NDS for authentication. NDS is managed in the domain of the communication-center resources and is part of CME.

In step 903 NDS checks authenticity of the identified client and assuming success passes the information back to the interface server. Now the client is authorized to use the interface server and to submit requests. In step 904 the interface server passes the client ES-specific identity to the ES for authentication. The enterprise system (ES) by definition equates to the domain of services and includes all configurable services. If the client is authorized to use the services in step 904, then the interface server assigns a special security identifier (SID) to the client in step 905. The SID assignment is, in a preferred embodiment, only active for a single session conducted between the client and the interface server. For example, if there is a server time-out breeched, then the client must be re-authenticated.

The steps described above are those of a two-level authentication procedure. The first level is server authentication that allows the client to use the server for particular requests and the second level is ES authentication that allows the client use the system. The ES security is based on CME resources. The interface server may, in some embodiments, be configured to skip server authentication, ES authentication, or both. Also, ES identity for the user may be kept in the NDS and retrieved from the NDS after successful authentication. This approach provides a very flexible way to configure security for the ES and in case of integration with CRM, permits a single login with different identities established for different ES instances.

Security is provided on the publicly accessible side of the system, by using SSL on transport layer and/or encrypting elements of the request/response using a public key. Client identity is established by a combination of three basic elements. These are principal name of client (user name, application name), entered credentials (password), and client system address, for example, http://www.client.com.

Each resource is an application in the ES that is tapped by the interface server between the client and the ES. Distinct resources include but are not limited to the configuration server (CfgServer), statistics server (StatServer), and transaction server (T-Server) server hosted in the communication-center domain. The exact types and availability of services depends in part on the makeup of the enterprise system hosting the interface server. The exact resources are specified upfront with a client request such as a request for configuration and statistical services.

There re many ways to determine which particular servers will be available to a particular client. For example, in CME a single server can be assigned for a particular application. The application name can be specified as part of the client ID, or in NDS for the particular client. Determination of which particular statistical server to use in the case of more than one is provided through the configuration service. In one embodiment a client may be configured to use more than one server but the client may specify which server to use in a request.

To reference a particular resource within the communication domain (enterprise system), a universal resource indicator (URI) may be used. For example, to reference a statistics server number 1, the following exemplary address may be used:

http://www.communicationcenter.com/statistics#StatServer 1.

An optional set of URI resources may be specified in any service request as a resource parameter. In one embodiment NDS can be used to register a URL of a server. In this case, any client can access it. Requests may comprise exemplary actions such as:

Login to an interfacing server for authentication to conduct the pending session.

Logout from the interfacing server to end an active session.

Cancel to terminate an active request already in the interfacing server and return acknowledgement of cancellation specific to each request.

More specific command requests include:

RetrieveConfiguration

SubscribeStatistics

RetrieveSubscribedStatistics to retrieve a current value of subscribed statistics or of a subscribed single statistic.

RetrieveStatistics to retrieve the current value of a specified statistic or statistics

RetrieveStatisticalProfile

The method and apparatus of the present invention provides access to pertinent statistical data pertaining to virtually any facet of communication-center state and operation. A variety of third-party applications such as plug in software modules, thin client applications and even automated robust systems can benefit from having real-time access to configuration and statistical information.

### Abstracting XML Vocabularies

According to one aspect of the present invention, a special XML protocol is provided that enables a higher level of abstraction in dealing with multiple XML-based languages and vocabularies that exist for specific types of applications used within the contact center. Methods and apparatus of the invention are described in detail below.

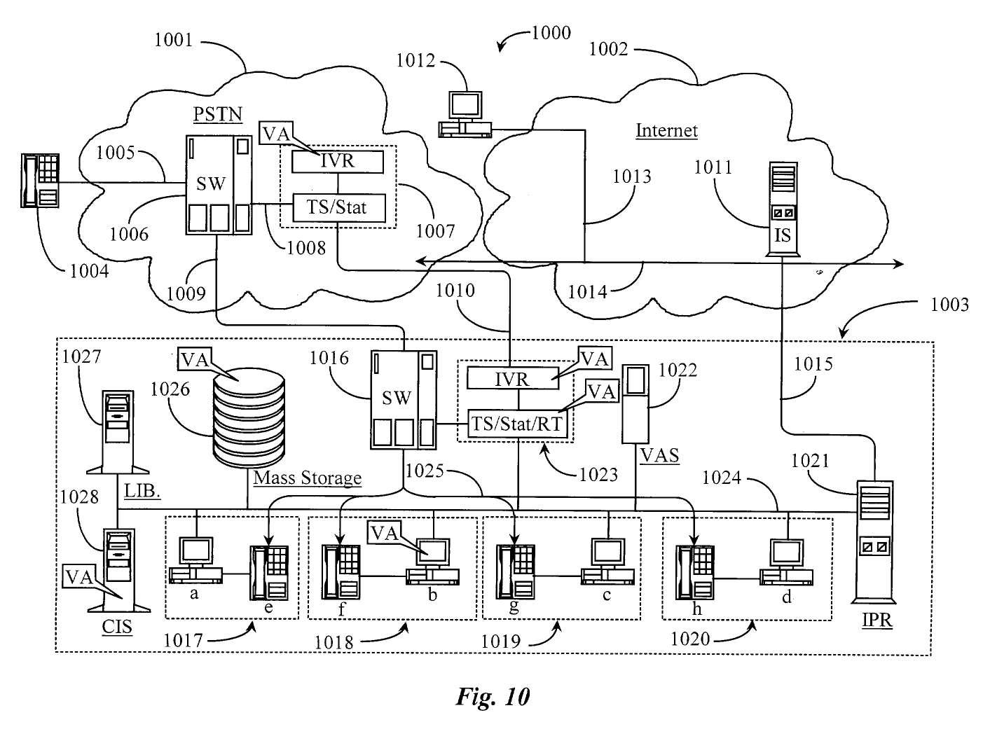

FIG. 10 is a basic architectural overview 1000 of a contact center running an IVR voice application. Architecture 1000 comprises a state-of-art contact center 1003 capable of handling both multimedia and connection oriented switched telephony (COST).

In this example, a data packet network 1002, and a telephony network 1001 provide access to center 1003 for customers, partners and third-party applications. Network 1001 is in a preferred example, the well-known public-switched-telephony-network (PSTN) and network 1002 is the well-known Internet network. In one embodiment, center 1003 could be a pure DNT center wherein incoming calls from PSTN 1001 are converted to data network telephony events before being processed within center 1003.

A telephony switch (SW) 1006 is illustrated within PSTN 1001 and represents a last routing point for telephony events destined to arrive at contact center 1003. A telephone icon 1004 connected to switch 1006 by telephony trunk 1005 represents a user placing a call to center 1003. Switch 1006 may be any type of known telephony switch or service point. Common switch types include automatic call distributors (ACDs) and public branch exchanges (PBXs).

Telephony switch 1006 is connected by way of a telephony trunk 1009 to a telephony switch 1016 provided as a central office switch within contact center 1003. Switch 1016 may be a PBX or an ACD, or other central switch types. Switch 1016 represents a first routing point within the physical domain of contact center 1003 for all COST events.

In this example, both telephony switches 1006 and 1016 are CTI-enhanced with connected processors. Telephony switch 1006 is enhanced for intelligent routing by a processor 1007 running an instance of IVR, Transaction Server (TS) and Statistics Server (Stat). Processor 1007 has connection to switch 1006 using a CTI link 1008. Switch 1016 within center 1003 is enhanced for intelligent routing by a processor 1023 connected to the switch by a CTI link 1029. Processor 1023 like processor 1007 is running an instance of IVR and TS/Stat Server. TS is known to the inventor and provides intelligent routing rules and control to both switches 1007 and 1023. Intelligent IVR applications in both mentioned switches provide voice interaction capabilities to center 1003 both internally and at the level of the network. In fact agent-level routing capability may be to provided at the vicinity of switch 1006 with all of the parameters controlled from within center 1003.

Processor 1007 within PSTN 1001 and processor 1023 within center 1003 are connected together for communication by a digital network connection. In this way information and data about callers and pending calls can be transmitted to agents of center 1003 ahead of the actual calls themselves. Voice applications (VA) can be executed at either processor or both of processors 1007 and 1023. In this example, voice interaction is set to occur with callers arriving at switch 1006 and at 1016. Eventually COST calls are routed to one or more of agents or automated systems supported by a local area network (LAN) 1024 provided within center 1003.

LAN network 1024 supports a plurality of agent stations illustrated in this example as agent stations 1017, 1018, 1019, and 1020. It will be appreciated by one with skill in the art of telephony contact centers that in actual practice there may be many more agent stations than re illustrated in this simple architectural view. Typically, each agent station has a LAN-connected computer. LAN-connected computers are illustrated respectively with each station as computers a-d one per station. Likewise, each station typically includes some type of telephone that may be provided in the form of a desktop, headset, or handset. Telephones are labeled herein telephones e-h one per station. In this example, switch 1016 has connectivity to all agent telephones e-h through internal telephony wiring for transmitting COST calls. It is noted herein as well that each telephone e-h is illustrated as having connectivity to respective computers a-d. This type of connection may be provided for data telephone peripherals so that IP telephony events arriving via LAN 1024 can be processed using familiar telephony equipment.

Internet 1002 may be assumed to contain all of the equipment like servers, connection points, gateways, routers, and so on that make up the Internet as a whole as exemplified logically by an Internet backbone 1014 extending through cloud 1002. Backbone 1014 extends into cloud 1001 to logically illustrate the actual ambiguity between the two networks in terms of shared lines and some shared equipment.

A computer icon given the element number 1012 represents a user accessing Internet 1002 via, typically a dial-up modem line 1013. An Internet Service Provider (ISP) is not illustrated in this example but may be assumed to be present. Other typical methods of connection for user 1012 may include cable modem, DSL, ISDN, including wireless alternatives like broadband.

An Internet or Interface server (IS) 1011 is illustrated within cloud 1002 and adapted, in a typical example as an Internet Web server capable of serving electronic documents known as Web pages and providing access to center 1003 through a variety of interactive media and mechanisms. For example, Web-based voice applications, e-mail, file sharing, instant messaging, file download, chat, v-mail, and DNT telephony applications may all be available to those accessing server 1011. Server 1011 is logically illustrated as connected to backbone 1014.

In one embodiment, server 1011 may also be an interface used by third party applications as was described with reference to the specifications reference in the cross-reference to related document section of this specification. In this case, access line 1015 would be a secure connection for uploading proprietary configuration data and statistical data. In still another embodiment, server 1011 may be capable of both third party and normal customer interface.

Server 1011 within cloud 1002 is connected to an Internet protocol router (IPR) 1021 maintained within center 1003 by an Internet access and connection line that can be a 24/7 connection such as DSL or any other type of access line that can be used to provided Internet presence, in this case server 1011 to center 1003.

IPR 1021 is the first entry point for multimedia and DNT events routed to center 1003 from Internet 1002. In actual practice, IPR 1021 may comprise more than one interface for dealing with different types of media. For example, an e-mail server may be art of the function represented and separated from a function for routing DNT event notifications. In this example, one machine is logically illustrated to represent routing of all Internet sourced data, which in some cases can even include COST users accessing server 1011 through a gateway (not shown) between PSTN 1001 and Internet 1002. In the latter case, a destination may include one of agent computers a-d or an automated customer interface system that may be present within center 1003.

IPR 1021 has a direct connection to LAN 1024 and routes all messages media event and data over LAN 1024 to intended destination nodes, namely agent stations 1017-1020. LAN 1024 is connected to a customer information system (CIS) server 1028 adapted to serve any stored information about a customer of center 1003 upon request from an accessing system or software application. A mass storage device 1026 is also illustrated as connected to LAN 1024. Device 1026 may be adapted to where house product information, history-based data, center performance statistics, actual interaction records, system configuration data, and any other type of data. It may be assumed that device or system 1026 also has database capabilities, server capabilities, and is mappable to external system components authorized to access it.

LAN 1024 is also directly connected to a voice application server (VAS) 1022 adapted to serve IVR and other voice applications that are distributed into the contact center environment including, in some instances, network systems like processor 1007 and IS 1011. VAS 1022 may be dedicated to voice applications in one embodiment, or may be responsible for serving all CC applications including voice applications. In this case a voice application (VA) is illustrated in progress between agent station 1018 and COST user 1004.

A library server (LIB) is directly connected to LAN 1024 and is adapted to support all XML-based languages used in distributed CC applications whether they are dynamic or static applications. LIB server 1027 may also contain libraries for appropriate Java-based code and other required application language libraries. An administrator constructing a CC application can obtain the appropriate XML object and resource tags as well as style sheets and other necessary components from server 1017.

As was mentioned in the background section, a typical VA application contains VXML (voice dialog) and CCXML (call control) components. In one embodiment known to the inventor the VA can be dynamic meaning that dialog scripts are chosen on the fly based on event triggers including interpretation of response from a customer or application user, which may also be a system.

Generally, a typical CC application like a voice application (VA) will be instanced at distributed system components where needed according to workflow of the application and interaction parameters. For example an instance of VA served by VAS 1022 will first manifest as IVR delivery and interaction with the customer 1004 at switch 1006, then if required again at switch 1016 before internal routing takes place. A VA application may include data access and retrieval functions, which may manifest at CIS server 1028, and perhaps at mass storage device 1026. In this case, the VA is also instanced at agent workstation 1018 as the destination of routing of the event initiated in this example by customer 1004.

One of the drawbacks to this current implementation is that simple voice applications are rather limited in capability of providing automated functionality that taps into higher-level CC capabilities. Therefore, additional CC applications may have to be spawned to perform some of these other functions like reporting results of interaction, computing values for updating database entries, or conferencing in persons operating with differing media vehicles. Similarly, if higher-level functions are to be covered by an application, separate business process rules need to exist that leverage the different modalities in terms of language use and process procedure. Therefore the complexity of these applications would increase exponentially with the added functionality supported. APIs, language conversion modules, and the like add to the expense of CC maintenance and operation.

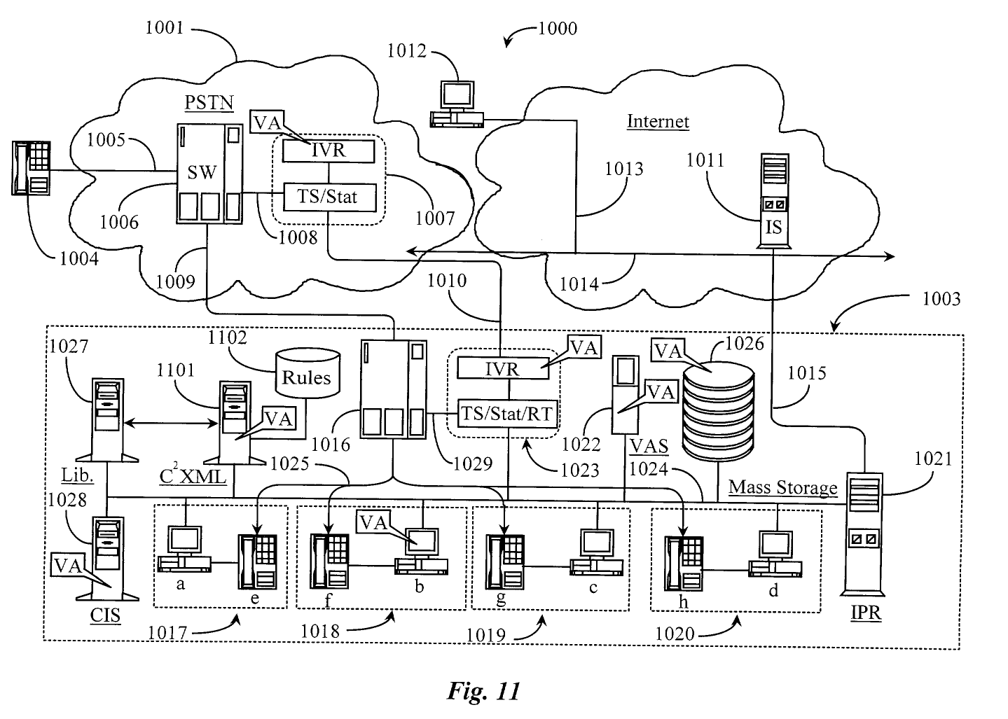

FIG. 11 is an architectural overview of contact center 1000 enhanced with a system for providing XML object and event description at a higher level of abstraction than application-specific XML implementations. Architecture 1000 contains all of the elements introduced with reference to the example of FIG. 10 above. For reasons of avoiding redundancy in description all of the elements re-illustrated in this example shall retain their original element numbers and basic description.

In order to provide a higher level of abstraction for treating multi-modal CC applications, the inventors provides an enhanced form of a contact-center markup language the inventors, for the purpose at least of this specification, term enhanced contact-center XML, which will herein be abbreviated as C² XML. C² XML is used to create business process scripts (rules) that can deal with multiple versions and vocabularies of XML-based markup languages. A C² XML server 1101 is provided within center 1003 and is directly connected to LAN 1024 and has a separate network connection to LIB server 1027. A rules base 1102 is provided in association with server 1101 and is adapted to store all business scripts used to enable XML session content included in a voice application. C² XML is an XML-based vocabulary that enables a single CC application to be built that can capture all of the functionality of the hosting center. C² XM is built on top of various supported markup languages and is used for the business process function of the XML delivery and implementation. More particularly C² XML enables representation of an entire CC application as a single XML document or as a set of linked XML documents.

Using C² XML gives a CC application including components for voice and call control, for example, the ability to perform many other contact center functions that are not possible with a current XML-based VA. A CC application governed by C² XML can include agent involvement in interactions including agent lookup operations and agent scripting as well as data reporting and calculation, using customer profiles, implementing outbound call campaigns, and managing multi-modal media interactions.

The present invention uses existing object modeling techniques to create a C² XML business process vocabulary that can leverage all of the different XML-based content vocabularies that exist in LIB server 1027. Each processing sub-system within contact center 1003, and in some cases systems external to center 1003 has access to a same set of C² XML rules for platform independent processing and rendering of session content.

Using the present example, assume that VXML vocabularies and CCXML vocabularies are supported by center 1003 and available by accessing LIB server 1027. A C² XML voice application served by server 1022 then uses a single or more than one C² XML business process script available from server 1101 to instruct contact center process systems like processors 1016 and even processor 1007 in treatment of all XML-based session content at the lower level of abstraction inserting the proper vocabulary variables into a single XML document or into a linked set of XML documents. One with skill in the art will appreciate that considerable streamlining of business processes and contact center software implementations can be achieved as well as improved platform independence in communication.

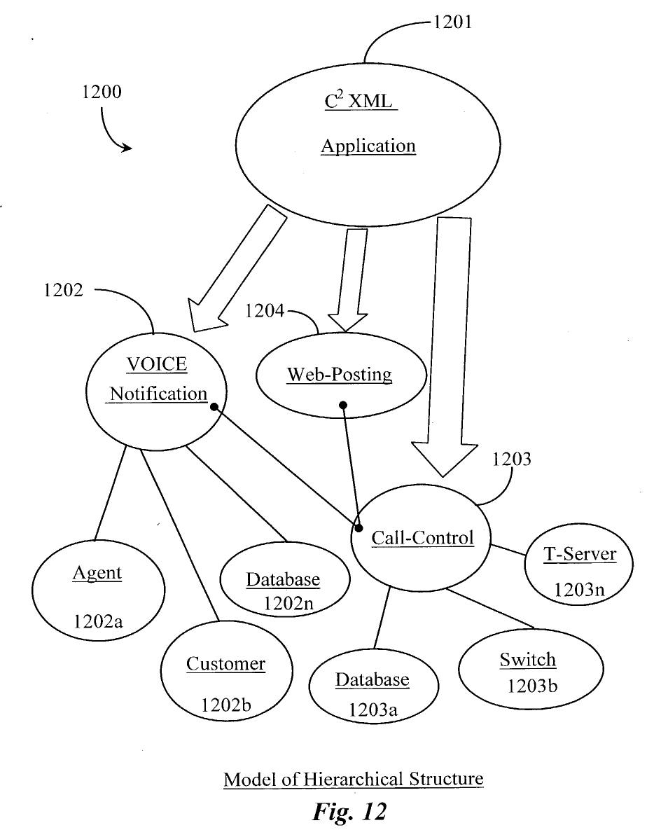

FIG. 12 is a block diagram illustrating a model hierarchy of an abstract C² XML application 1201 and CC elements it controls. C² XML application 1201 is analogous to a functional CC program containing one or more C² XML process scripts stored in rules base 1102 and served by server 1101 described with reference to FIG. 11 above. In this example only a very simple structure for internal CC processing is represented for exemplary purpose. Application 1201 is a C² XML program that defines a business process or set of business processes for executing one or more contact center functions. As a program instance that defines one or more processes for defining and treating XML-based content using the standard techniques, such as including but not limited to descriptor files etc., application 1201 has relation to one or more C² XML processes represented in this example as a voice notification process object 1202, a Web Post process object 1204, and a Call Control process object 1203. A process object is not limited to treating a single XML-based vocabulary, but may treat more than one vocabulary in a single XML document depending on variable parameters that might occur. For example, there is more than one modality for achieving outbound voice notification. For example, outbound notification with synthesized voice may be accomplished through IVR/Telephony procedure, and with voice mail Web/based procedure or voice posting on a Web site.

It should be noted that the particular example provided is for voice interaction, but the invention is not limited to voice interaction, and may be used with e-mail, chat systems, and so forth, as well.

Processes 1202, 1203, and 1204, and therefore C² XML application 1201, are written using C² XML. The just-mentioned processes work with standard communication-center objects that are part of an existing contact center call model in this instance. One C² XML application may contain an unlimited number of C² XML processes defined as a collection of all of the processes that will or might, under certain conditions, occur in execution of the application as active process threads. As such, process threads may communicate with each other and with lower level objects. Processes may execute in parallel and/or in sequence depending on design.

Outbound voice notification process 1202 controls voice activated notification and works with standard CC objects 1202a-1202n in this example. CC object 1202a is an agent object. CC object 1202b is a customer object. CC object 1202n is a database object. Process object 1202 contains all of the required C² XML script for sending a voice notification to specified agents (1202a) and to specified customers (1202b) with lookup instructions and data retrieval instructions for accessing and retrieving required data from one or more databases (1203n).

It will be appreciated that there may be many more CC-objects represented in this example than are illustrated and that the CC objects themselves will have specific attributes and state conditions that may affect process implementation, which is an outbound notification campaign that is typically triggered by some contact center event. It will also be appreciated that there are different modalities of voice notification that come into play. For example, some agents will be notified by voice mail initiated and routed to receiving agents over the internal LAN network. Customers will be notified by an outbound telephony dialing campaign using an IVR system. The underlying XML-markup language is XML for IVR scripting and for integration into voice mail. However the modalities using the markup differ having differing vocabulary terms associated with the different delivery mechanisms.

Notification process 1202 contains a script that includes the vocabularies and instructions for both delivery mechanisms in a single XML document. The session content (Voice notification) is the same for both modalities but a single processing script and XML document can be used to provide the system instructions for completing the task. The variables are dynamically inserted into the VXML routine based on the intended implementation.

Notification object 1202 requires Call-Control object 1203 to effect the CCXML instructions for call control parameters surrounding the IVR notification to customers. As such objects 1202 and 1203 are parallel processes that can be associated to use the same business logic C² XML instruction and the same XML document for content. Call control object 1203 uses CC objects Database 1203a, Switch 1203b, and T-server 1203n. Note that there are only 2 levels required in the hierarchy, C² XML business instruction and the CC-objects used in carrying out the application task.

A Web-Post object 1204 defines another notification modality. Object 1204 defines the process of posting the voice notification on a Web site along with agent and customer outbound notification. Web Posting requires both VXML parameters and CCXML parameters. Although there are no CC objects illustrated as used by process 1204, it may be assumed that certain new CC objects may come into play such as a Web Server object, a Switch Object, and a Database object. Web posting requires VXML, CCXML, HTTP/WML, or XML-based vocabularies depending on the site parameters.

The business logic written in C² XML can combine all of the modalities into one executable C² XML script that defines a single XML template that contains the variable fields for insertion of the proper tags, namespace values, and application domain specific XML vocabularies. The C² XML application of the present invention could be executed and run until termination sharing one abstract set of instructions (business logic) and one shared XML document. Multiple scripts and multiple application specific XML documents normally required to run such a high level functionality are not required.

In some very simple applications the only inserted variables consist of C² XML tags for reporting and for database manipulation, such as bringing contact center context like customer profile, transaction details, and the like. For example, if a customer calls the contact center using a specific 800 number to buy a product that was identified in a catalog, the center application locates an associated IVR script and activates the script. The voice application then looks up the customer's profile in a database. Identification can be based on automatic number identification (ANI) service. Assuming the data is found, the application reads information about customer's payment data such as credit information and the like.

The IVR then interacts with the customer according to the script and finds out what the customer is looking for. More specifically, the IVR collects information from the customer about a catalogue number, any additional client-based data and so on. If a purchase is completed the IVR records the figure of the revenue generated from the transaction. Then the IVR de-activates the dialogue.

After terminating the call, the IVR reports the revenue value to a database. If the customer entry in the database is outdated, the application may update the customer's profile including adding the record detailing the transaction. If the customer was a new customer, the application might create a customer profile beginning with the information obtained during the interaction.

An application that provides the above-described functionality can be implemented using CCXML as a base and VXML for the voice dialog. The CCXML of the application defines a simple state machine. The VXML dialog is activated when a corresponding transition state fires. C² XML tags are added for specifying database reading and writing, and for data reporting after a transaction. Customer profile data may be stored in XML-based for in a CIS system analogous to CIS 1028 of FIGS. 10 and 11. A native XML-based database or a conventional database with an XML adapter can be used. Reporting tags (<REPORT>), for example, may contain C² XML elements that define what is to be reported and where it is to be reported. The actual dictionary could be different. CCXML script can be determined dynamically within the CC environment by using a destination number identification service (DNIS) or other identification techniques. In one embodiment the root application can be defined upfront. It is noted herein that both CCXML and VXML have the same syntax for manipulation of variables.

All kinds of possible machine-to-machine with agent interaction scenarios can be defined using C² XML instruction tags, which in some embodiments can be dynamically inserted based on event transitions in a chain of events. There are many possibilities.

In another embodiment a C² XML application runs for a specified time period wherein dynamic interaction processes appear and terminate within the life of the main application. An example of this would be agent or agent group shift monitoring where total revenue figures for a single agent or for a group of agents are reported at shift-end. The application can also be extended to automated-transaction-capable processes such as IVR and E-mail mechanisms.

An application begins when for example, an agent logs on to a contact center system and begins processing interactions. The main application is represented as an XML document with variable fields to store revenue values. The application in this case is associated with the CC-object agent and lives as long as the agent is logged into the system. The application collects values for each dynamic interaction that occurs during the life of the main application and reports the total revenue figure to a database when the agent log's off. Typically interactions of a same media type would not be allowed to overlap; however transactions of different media types may appear and be processed concurrently. For example, an agent may be concluding a telephone transaction that has generated a revenue value for reporting while at the same time closing an on-line order transaction that has also generated revenue. Both revenues will be isolated and figured in with the total revenue. In one embodiment a second XML document can be used in parallel and as a slave to a first (primary) document to track any dynamic interaction processes of a same media type that appear after a previous one has started but before the previous one has been completely processed.

In one embodiment the basic model of this example can be expanded to provide C² XML application execution and distribution to remote third party entities for performing statistics reporting and configuration updating among other functions. This can be accomplished using an interface server and application containers that contain special content rendering components based on the application specific domain of the third party application.

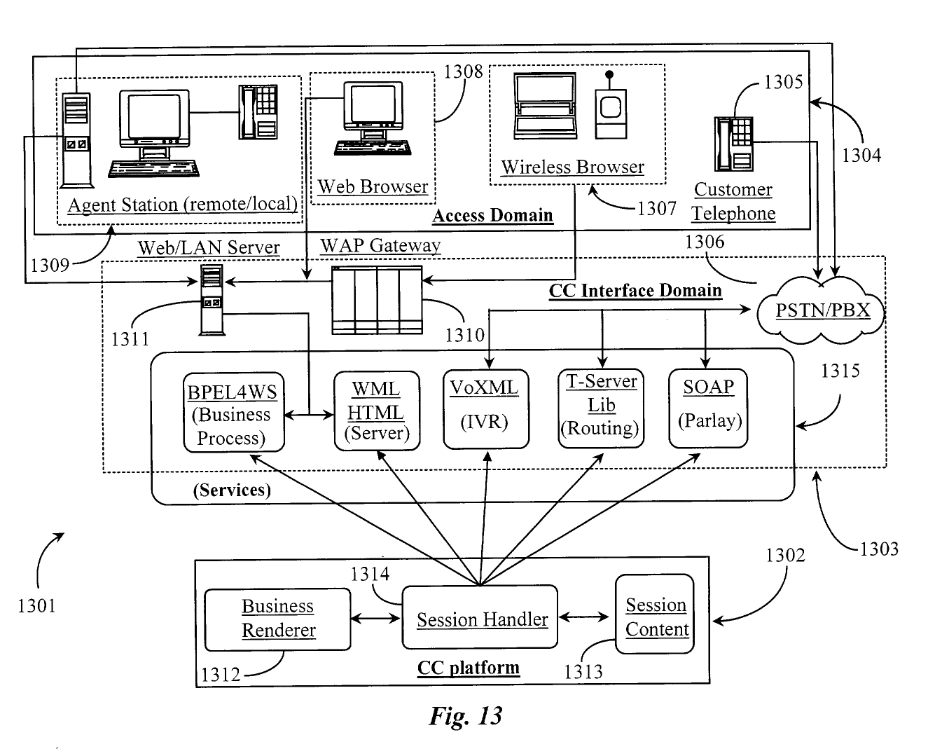

FIG. 13 is an architectural diagram illustrating application deployment logistics of the present invention in a third-party scenario. Remote mapping capabilities across domains and platforms is performed in a domain and platform independent manner because C² XML provides an abstract application domain description above individual content platforms and operating domains. System 1301 comprises a communications environment somewhat similar to the system architectures described with reference to FIGS. 1 and 2 above. System 1301 comprises a CC platform 1302 analogous to CC platform 200 of FIG. 1, a CC interface domain 1301 (logically illustrated), and an access domain 1304 (logically illustrated). Access domain 1304 represents third party systems, networking devices and software (browser) used to access CC platform 1302 through CC interface domain 1303.

Interface domain 1303 may be assumed to include an illustrated PSTN/PBX network given the element number 1306, a WAP gateway illustrated herein as gateway 1310 for wireless access, and a Web/LAN server illustrated herein as server 1311 for standard Web access. The inventor illustrates intermediary equipment namely server 1311, gateway 1310 and PSTN/PBX 1306 for purpose of illustrating separation of access methods only. In actual practice of the invention interface domain 1303 may have vague boundaries that extend into the PSTN network, the Internet network or a wide-area-network, and also into the physical CC center domain such as connected to an internal LAN or a corporate WAN/LAN that connects a number of separate CC center hubs arrayed over a geographic region like a campus setting. Any manner of computer and telephony equipment may fall under the category of interfacing equipment whether located internally or externally from platform 1302.

A customer telephone 1305 is logically illustrated within access domain 1304 and represents any third party (typically a center customer) accessing CC platform 1302 through PSTN/PBX 1306. A customer accessing through PSTN/PBX 1306 would typically be serviced through one or a combination of voice and call routing services illustrated within services 1315 logically located within CC interface domain 1303. For example, a VXML capable IVR service is illustrated adjacent to a T-server Library (Lib) service for transaction rules and intelligent routing services. A voice portal service known as Parlay is also illustrated as a service available to a third party accessing through telephone 1305 and network 1306.

A web-based wireless browser component 1307 is illustrated within access domain 1304 and represents a third party such as a partner or agent gaining access to CC platform services using a wireless Web browser application on a Laptop, cellular, or other hand-held device. Access to services is made in this example through WAP gateway 1310 adapted to provide a gateway to services that are available through server 1311. A user accessing from a wireless browser could be a partner, agent, or customer.

A standard Web browser component 1308 is illustrated within access domain 1304 and represents a business partner accessing platform 1302 from a network-connected computer. Typically this type of access is HTML-based from server 1311. Browser component 1308 may also represent customer and agent access. A remote/local agent station 1309 is illustrated within access domain 1304 and represents, principally, a remote agent station accessing server 1311 for Web-based services described further below. Access may be accomplished through dial-up through PSTN 1306, or through direct network access lines (both paths illustrated).

Services 1315 also includes grouping of CC platform-supported Web services that are XML-based. For example, a Business-Process-Execution-Language-for-Web-Services (BPEL4WS) is illustrated at far left in services block 1315. BPEL4WS is a specification for a programming language that enables a task to be accomplished using a combination of Web Services, often involving more than one company. A WML/HTML service (server) is also illustrated for Web access both wired and wireless. Arrow trees connecting equipment to services imply the typical paths from access device to interface component. Services are illustrated externally from interfacing machines and networks for explanative purposes only.

In the course of transacting with platform 1302 from the view of access devices, the fact that CC objects and events are represented in terms of C² XML for interface processing purposes is largely if not completely transparent. Third parties may gain normal access to services as long as their access applications are supported by the appropriate vocabularies within the center platform. CC platform 1302 uses C² XML for communicating business process to interfacing machines using an executable container that contains C² XML components and the appropriate XML-based content. The C² XML implementation resides within the web container and is either remote or co-located with integration components/drivers and is based on natural extensibility of XML protocols and documents.

A remote C² XML application enables elements of CC center business logic to be reused across different markup languages. Existing XML standards like VXML, CCXML, and SOAP can be reused in an application where new CC business logic is added without causing compatibility issues. C² XML language extensions are provided in the form of a software layer on top of other languages. C² XML abstract XML can be efficiently provides using a relatively small set of XML elements.

Platform 1302 uses a C² XML session handler illustrated herein as session handler 1314 to direct an application session that is being conducted across an open platform to a remote interface. At least one C² XML business renderer 1312 applies the appropriate business logic as one or more C² XML processes. To complete a distributed container, session content, illustrated herein as session content 1302 is included in the package in the form of one or a set of XML documents containing the variable fields for application specific rendering. In one embodiment, a lite C² XML plug in (not shown) is provided to various interfacing machines (processing points) that will enable the machines to identify and execute the C² XML containers in a platform independent manner.

C² XML has it own underlying contact center call model that has all of the association and inheritance capabilities to work with the standard contact center call model, which can be Java-based. In a distributed environment each C² XML object has a counterpart object that exists in the standard contact center model. In this way, much of the interface APIs and language transformation and rendering mechanisms described with reference to FIGS. 1-3 can be eliminated or simplified. Special C² XML tags are provided to enable at least the following functions:

Tags for mapping markup elements to business content: This includes requesting for resource profiles, partner profiles, customer profiles and other business request attributes.

Tags for requested resource allocation: This function is based on profiles and request attributes.

Tags for direct resource assignment;

Tags for indirect resource assignment;

Tags for verifying resource availability;

Tags for delivering and mapping results from resource specific logic to business process logic; and

Tags for resource-specific event handling in the context of a defined business process;

In a preferred embodiment session content 1302 is represented as an XML document, for example, an eXtensible stylesheet language Transformation (XSLT) or XML Path Language (XPATH). While some more recently developed XML-based markups are now built on top of more primitive XML syntax, ^{C}^{²} ^{XML} provides a manipulation of these variable markups that is truly platform and application independent at the machine processing level. The end user realizes results according to application specific requirements in a transparent fashion.

Modularity of ^{C}^{²} ^{XML} components is realized through special sets of tags as previously described. For example, tags for agent manipulation functions are separate from tags for statistical reporting thus supporting the modular and separate CC capabilities. The tags are extendible as well to accommodate emerging CC functionality.

In one embodiment using a third-party example, a ^{C}^{²} ^{XML} application may be only a part of a more complex customer relations management application (CRM). Therefore, ^{C}^{²} ^{XML} tags are insert able into any of the XML documents carried in the CRM application much like SALT tags are insert able into any HTML document.

A CCXML model is based on an underlying CC model in terms of call leg construction, voice dialog, conference object, etc. A ^{C}^{²} ^{XML} model has its own set of objects related to CC related events and objects like agent, report, customer, and so on. In fact a CC model plays a role in developing the semantics of ^{C}^{²} ^{XML}.

In a preferred embodiment, a ^{C}^{²} ^{XML} application comprises two groups of objects, ^{C} ^{²} ^{XML} processes and ^{C}^{²} ^{XML} objects. The grouping of ^{C}^{²} ^{XML} objects defines a set of objects that the ^{C}^{²} ^{XML} processes will work with. Each ^{C}^{²} ^{XML} object has one counterpart CC object in the CC platform. A ^{C}^{²} ^{XML} object may inherit all attributes and methods of a counterpart CC object. Additionally, a ^{C}^{²} ^{XML} object may exhibit additional application specific attributes and methods not defines in the CC object counterpart. For example, a CC object, say a customer has standard attributes like address, telephone, payment information, and so on, however if the CC application is selling hairbrushes to the customer, the application may require some additional attributes that may be temporary like the nature of the customer's hair. Although this is purely conjecture in terms of a real CC application, if the additional attributes are attainable they can be presented as additional attributes of a CC object that live only as long as the application lives. These additional attributes can then be manipulated by the ^{C}^{²} ^{XML} processes of the ^{C}^{²} ^{XML} application.

^{C}^{²} ^{XML} processes specify the application logic used to manipulate the objects. A ^{C}^{²} ^{XML} process instance is the active thread of a ^{C}^{²} ^{XML} process. A single ^{C}^{²} ^{XML} application may have multiple ^{C}^{²} ^{XML} processes and a single ^{C}^{²} ^{XML} object may correspond to several ^{C}^{²} ^{XML} process instances. The number of possible ^{C}^{²} ^{XML} processes that can occur in an application is not limited. For example if every possible interaction scenario in a CC center is defined as a ^{C}^{²} ^{XML} process then there will be the same number of processes in the application as there are interaction possibilities in a CC center.

In order to ensure that ^{C}^{²} ^{XML} process instances can communicate with ^{C}^{²} ^{XML} objects a send/receive mechanism is used under specific rules. For example, a ^{C}^{²} ^{XML} process instance may communicate bi-directional with ^{C}^{²} ^{XML} objects and other ^{C}^{²} ^{XML} process instances. ^{C}^{²} ^{XML} processes may communicate only with their associated process instances but not with each other. Tag control and event handling techniques known in the art are used to facilitate the communication. For example, if a ^{C}^{²} ^{XML} process instance or object needs to generate some event at a given time has a send tag inserted at the proper place in the specification. The send tag can contain a list of variables for selecting the parameters of the event. Likewise, a ^{C}^{²} ^{XML} process instance or object that needs to receive an event at a particular time has an event listener tag inserted in the proper place in the specification that is activated when the event is received.

The method and apparatus of the present invention can be practiced only internally within a single contact center, or in relation to third-party environments supporting cross platform and cross domain functionality. In one embodiment, a ^{C}^{²} ^{XML} application may consist of all of the possible processes and objects that are available within a CC model wherein all of the separate processes are organized and indexed such that portions of the application can be identified and executed as a sub-application. Any additional attributes, objects, events, and so on that emerge from the CC-model are updated into to the ^{C}^{²} ^{XML} model so that the new functionality is now represented in abstraction in the ^{C}^{²} ^{XML} application.

One with skill in the art will appreciate that there are a variety of network types and implementations that can be utilized to practice the invention beside the Internet. Private networks, Ethernets, Intranets, and LANs can be adapted for practice of the invention. Combinations of the above-described networks may also be used to practice the invention.

The methods and apparatus of the present invention should be afforded the broadest scope under examination. The spirit and scope of the present invention shall be limited only by the following claims.

What is claimed is:

1. An object oriented business application for controlling events and sequences thereof, the events and sequences thereof expressed in variant descriptive languages and application specificities, comprising:
at least one process object defining a specification describing at least one process; and
at least one process instance materializing as an active process thread upon execution of the at least one process object;
characterized in that an event or sequence thereof associated with all or part of the at least one process object triggers execution of the at least one process object activating at least one process instance that controls processing and termination of the event or sequence thereof including processing post termination tasks, the application and functions thereof expressed in an abstraction of the variant descriptive languages and application specificities of the events and sequences thereof.

2. The business application of claim 1 wherein the application controls event sequences occurring in a telephony environment, the event sequences including multimedia interactions.

3. The business application of claim 1 wherein the event sequences include party-to party-interactions, party-to-machine interactions, machine-to-machine interactions, and machine-to-party interactions, party defining one of a live agent, a live customer, or a live business partner.

4. The business application of claim 1 wherein the triggering event is one of an incoming telephone call, an incoming multimedia event, a machine notification, a machine request, or an agent-initiated event.

5. The business application of claim 1 wherein the event is an incoming telephone call and a processed sequence of events define interaction between a communicating party and an interactive voice response system.

6. The business application of claim 1 wherein the event is an incoming machine request and a processed sequence of events define an automated machine-to-machine request and response sequence.

7. The business application of claim 1 wherein the events and event sequences are variant from each other in terms of descriptive language and application specificity, the descriptive language variances comprising one or a combination of XML syntax differences, style differences and vocabulary differences.

8. The business application of claim 1 wherein the abstract descriptive language of the application, process object, and process thread is XML-based and the variances of the different descriptive languages of the events processed or event sequences processed are satisfied during processing by inserting language specific and application specific syntax into variable fields provided within one or more XML-based templates, the syntax available to the application by accessing a language library.

9. The business application of claim 1 wherein the at least one process instance inserts operation and identification tags during processing XML documents to enable various functions of a contact center platform including communication with other process instances and objects of the process.

10. The business application of claim 1 further comprising:
a plurality of communication-center objects, the objects described in the abstract language of the application, process objects, and process instances, each object corresponding to a counterpart object residing within the contact center platform, the counterpart objects modeled and described at a lower level of abstraction.

11. The business application of claim 10 wherein the application functionality is extended to third-party interfaces held externally from the contact center platform enabling platform and application independent processing across multiple domains.

12. The business application of claim 10 wherein the interface includes one of an IVR capable telephone switch, a Web server, a LAN server, or a network gateway.

13. In a multimedia communications environment, a method for machine processing of multi-modal interaction or business process sequences across multiple application-specific environments according to business application logic comprising steps of:
(a) receiving a triggering event at an interfacing node;
(b) executing upon trigger a business process object of an object oriented application;
(c) spawning at least one process instance for applying the appropriate application business logic to enable the interaction sequence;
(d) accessing any related interaction objects of the interaction sequence sequentially according to process instance order;
(e) inserting by tagging and executing the order of tasks described by the business application logic during run of the at least one process instance on the accessed objects in sequential order; and
(f) terminating the process instance or instances running upon completion of the ordered tasks.

14. The method of claim 13 wherein in step (a) the triggering event is one of an incoming call, an incoming multimedia request, a machine notification, a machine request, or an interaction request initiated by an application or live party.

15. The method of claim 13 wherein in step (a) the interfacing node is one of a telephony switch, a Web server, or a network gateway.

16. The method of claim 13 wherein in step (b) the object oriented application uses an abstraction of XML based language at least one level of abstraction above the levels of XML based languages of the application specific domains of the parties of the interaction or event sequences.

17. The method of claim 13 wherein in step (b) the process object provides at least one XML template with variable fields therein for inserting syntax of application specific nature and for inserting tags to enable transient processes executing functional tasks.

18. The method of claim 13 wherein in step (c) more than one process instance is spawned in response to a single triggering event.

19. The method of claim 13 wherein in step (d) the process instance works with abstract objects, each abstract object having a counterpart object of a lower abstraction residing within the domain of the host of the communications environment.

20. The method of claim 13 wherein in step (e) the tags are inserted into variable fields of an XML document, the tags themselves containing variables for selection and execution according to prevailing business logic.

21. The method of claim 13 wherein in step (e) the at least one process instance includes logic for completing tasks after an interaction sequence terminates.

22. The method of claim 21 wherein in step (e) a post interaction task includes one or a combination of revenue reporting, statistical reporting, profile updating, and historical updating according to results of processing.
